(19) United States
(12) Patent Application Publication
(10) Pub. No.: US 2014/0126111 A1
(43) Pub. Date: May 8, 2014

(54) MULTILAYERED CERAMIC ELECTRONIC COMPONENT AND FABRICATING METHOD THEREOF

(71) Applicant: SAMSUNG ELECTRO-MECHANICS CO., LTD., Suwon (KR)

(72) Inventors: Young Ho KIM, Suwon (KR); Ro Woon LEE, Suwon (KR)

(73) Assignee: SAMSUNG ELECTRO-MECHANICS CO., LTD., Suwon (KR)

(21) Appl. No.: 13/746,626

(22) Filed: Jan. 22, 2013

(30) Foreign Application Priority Data
Nov. 5, 2012 (KR) 10-2012-0124299

(51) Int. Cl. H01G 4/12

(52) U.S. Cl. CPC H01G 4/12
USPC 361/321.2; 29/25.42

(57) ABSTRACT

There is provided a multilayered ceramic electronic component including: a ceramic body including dielectric layers; internal electrodes disposed to face each other, having the dielectric layer therebetween; and external electrodes formed at an outer side of the ceramic body and respectively electrically connected to the internal electrodes, wherein the internal electrodes include a single ceramic layer therein. The disconnection generated by a difference in contraction and extension rates due to a difference in the sintering temperature between the internal electrodes and the dielectric is prevented and the electrode connectivity and the coverage are maintained, whereby the high capacitance multilayered ceramic electronic component having excellent reliability may be implemented.

### CROSS-REFERENCE TO RELATED APPLICATIONS

This application claims the priority of Korean Patent Application No. 10-2012-0124299 filed on Nov. 5, 2012, in the Korean Intellectual Property Office, the disclosure of which is incorporated herein by reference.

### BACKGROUND OF THE INVENTION

1. Field of the Invention

The present invention relates to a high capacitance multilayered ceramic electronic component having excellent reliability and a fabricating method thereof.

2. Description of the Related Art

In accordance with the recent trend for the miniaturization of electronic products, demand for small, multilayered ceramic electronic components having a high capacitance has increased.

Therefore, dielectric layers and internal electrodes have been thinned and stacked in increasing amounts through various methods. Recently, as the thickness of dielectric layers has been reduced, multilayer ceramic electronic components having increased numbers of stacked layers have been fabricated.

A general fabricating method of a multilayered ceramic capacitor includes preparing a slurry, by mixing a ceramic powder, a binder and a solvent and printing a conductive paste to form internal electrodes, and separating a ceramic sheet from a film to form a green ceramic multilayered body. A green chip is fabricated by compressing the green ceramic multilayered body at a high temperature and high pressure to form a hard green multilayered body (Bar) and then performing a cutting process thereon. Then, the ceramic multilayered capacitor is completed by performing a plasticizing process, a firing process, a polishing process, an external electrode applying process, and a plating process thereon.

Here, stress between the internal electrodes and the dielectric layers, generated by a difference in contraction and extension rates, causes disconnection. A disconnected part is present in a secondary phase form due to a reaction between an additive and nickel, and the secondary phase form has a negative influence on capacitance and breakdown voltage (BDV).

Therefore, it is necessary to maintain electrode connectivity and coverage and prevent a decrease in capacitance to improve reliability through a technology that an internal electrode layer is printed on a dielectric sheet, a ceramic layer is applied to the internal electrode layer, and the internal electrode layer is re-printed on the applied ceramic layer to form a single internal electrode layer having a two-layer structure; even in the case that pores are generated due to a difference in a contraction rate between two materials generated due to a difference between the sintering temperatures of two materials caused by co-firing of the dielectric and the internal electrode layer.

### RELATED ART DOCUMENT

Korean Patent Laid-Open Publication No. KR 2011-0072396
Japanese Patent Laid-Open Publication No. JP 2007-142295

### SUMMARY OF THE INVENTION

An aspect of the present invention provides a high capacitance multilayered ceramic electronic component having excellent reliability capable of preventing disconnection generated by a difference in contraction and extension rates due to a difference in sintering temperatures between internal electrodes and dielectric layers, and maintaining electrode connectivity and coverage by including a ceramic layer within an internal electrode layer and co-firing a dielectric and an internal electrode layer.

According to an aspect of the present invention, there is provided a multilayered ceramic electronic component including: a ceramic body including dielectric layers; internal electrodes disposed to face each other, having the dielectric layer therebetween; and external electrodes formed on an outer side of the ceramic body and respectively electrically connected to the internal electrodes, wherein the internal electrodes include a single ceramic layer therein.

The internal electrodes may include two metal layers and a single ceramic layer formed between the two metal layers.

The two metal layers may include nickel (Ni).

The ceramic layer may have a thickness corresponding to 10% to 30% of a thickness of the internal electrode.

The ceramic layer may include barium titanate (BaTiO₃).

The number of multilayered dielectric layers may be 100 to 1000.

According to another aspect of the present invention, there is provided a fabricating method of a multilayered ceramic electronic component, the fabricating method including: preparing ceramic green sheets including dielectric layers; forming an internal electrode pattern on the ceramic green sheet by using a conductive paste for an internal electrode including a conductive metal powder and a ceramic powder; multilayering and sintering the green sheets respectively having the internal electrode pattern formed thereon to form a ceramic body including internal electrodes therein, the internal electrodes being disposed to face each other; and forming external electrodes on upper and lower surfaces of the ceramic body and at end surfaces thereof, wherein the forming of the internal electrode pattern is performed by forming a first metal layer on the ceramic green sheet, forming a ceramic layer on the first metal layer, and forming a second metal layer on the ceramic layer.

The internal electrodes may include two metal layers and a single ceramic layer formed between the two metal layers.

The conductive metal powder may be at least one of silver (Ag), lead (Pb), platinum (Pt), nickel (Ni), and copper (Cu).

The ceramic layer may have a thickness corresponding to 10% to 30% of a thickness of the internal electrode.

The ceramic layer may be printed by at least one selected from a group consisting of a screen printing method, a chemical vapor deposition (CVD) method, and a physical vapor deposition (PVD) method.

The ceramic layer may include barium titanate (BaTiO₃).

The number of multilayered dielectric layers may be 100 to 1000.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically showing a multilayered ceramic capacitor according to an embodiment of the present invention;

FIG. 2 is a cross-sectional view taken along line A-A′ of FIG. 1;

FIG. 3 is a flow chart showing a process of forming an internal electrode including a ceramic layer therein according to an embodiment of the present invention; and

FIG. 4 is a view showing a fabricating process of a multilayered ceramic capacitor according to another embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements maybe exaggerated for clarity, and the same reference numerals will be used throughout to designate the same or like elements.

A multilayered ceramic electronic component according to an embodiment of the present invention may be used appropriately in a multilayered ceramic capacitor, a multilayered varistor, a thermistor, a piezoelectric element, a multilayer substrate, or the like, having a structure in which a dielectric layer corresponding to a ceramic layer is used and internal electrodes face each other, having the dielectric layer therebetween.

Embodiments of the present invention will now be described in detail with reference to the accompanying drawings.

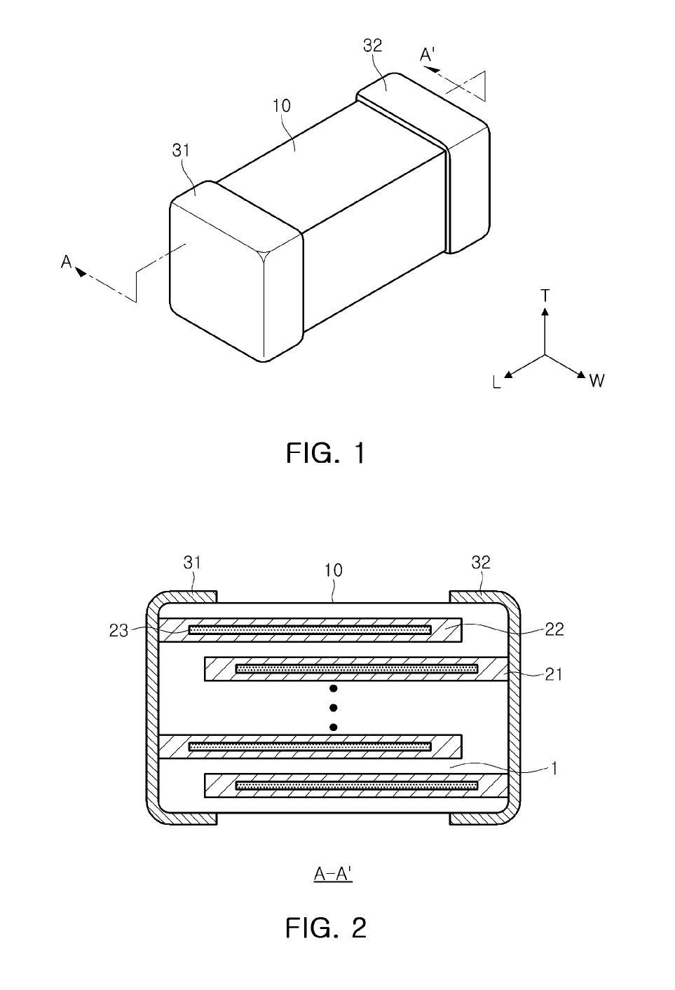

FIG. 1 is a perspective view schematically showing a multilayered ceramic capacitor according to an embodiment of the present invention.

FIG. 2 is a cross-sectional view of line A-A′ of FIG. 1.

Referring to FIGS. 1 and 2, the multilayered ceramic electronic component according to the embodiment of the present invention may include: a ceramic body 10 including a dielectric layer 1; internal electrodes 21 and 22 disposed to face each other, having the dielectric layer 1 therebetween in the ceramic body 10; and external electrodes 31 and 32 respectively electrically connected to the internal electrodes 21 and 22.

Hereinafter, the multilayered ceramic electronic component according to the embodiment of the present invention will be described. In particular, a multilayered ceramic capacitor will be described. However, the present invention is not limited thereto.

In the multilayer ceramic capacitor according to the embodiment of the present invention, a ‘length direction’ refers to an ‘L’ direction, a ‘width direction’ refers to a ‘W’ direction, and a ‘thickness direction’ refers to a ‘T’ direction of FIG. 1. Here, the ‘thickness direction’ is the same as a direction in which dielectric layers are multilayered, that is, a ‘multilayered direction’.

The ceramic body 10 may generally have a rectangular parallelepiped shape, but is not particularly limited thereto. In addition, the ceramic body may have a size of 0.6 mm×0.3 mm and may be a multilayered ceramic capacitor having relatively many multilayers and high capacitance of 1.0 μF or more. However, the present invention is not limited thereto.

According to the embodiment of the present invention, a raw material forming the dielectric layer 1 is not particularly limited as long as sufficient capacitance may be obtained therefrom, but may be, for example, a barium titanate (BaTiO₃) powder.

In a material forming the dielectric layer 1, various ceramic additives, organic solvents, plasticizers, binders, dispersing agents, and the like, may be added to a powder such as a barium titanate (BaTiO₃) powder, or the like, according to a purpose of the present invention.

An average particle diameter of the ceramic powder used in forming of the dielectric layer 1 is not particularly limited, but may be controlled in order to achieve a purpose of the present invention. For example, the average particle diameter of the ceramic powder may be controlled to be 400 nm or less.

An average thickness of the dielectric layer 1 is not particularly limited, but may be 1.0 μm or less.

A dielectric composition according to the embodiment of the present invention shows a relatively excellent effect in the case in which the average thickness of the dielectric layer 1 is 1.0 μm or less, and the thickness of the dielectric layer 1 may refer to an average thickness of the dielectric layer 1 disposed between the internal electrodes 21 and 22.

In addition, a dielectric constant of the dielectric layer 1 is not particularly limited, but may be 3000 or more.

One ends of the internal electrodes 21 and 22 may be alternately exposed to ends of the ceramic body 10 in a length direction.

A material forming the internal electrodes 21 and 22 is not particularly limited, but may be a conductive paste formed of at least one, for example, silver (Ag), lead (Pb), platinum (Pt), nickel (Ni), and copper (Cu).

In addition, the internal electrodes 21 and 22 may include ceramic, and the ceramic is not particularly limited, but may be barium titanate (BaTiO₃).

In order to form the capacitance, the external electrodes 31 and 32 may be formed on outer surfaces of the ceramic body 10, and may be respectively electrically connected to the internal electrodes 21 and 22.

The external electrodes 31 and 32 may be formed of the same conductive materials as those of the internal electrodes, but are not limited thereto. For example, the external electrodes 31 and 32 may be formed of at least one selected from a group consisting of copper (Cu), silver (Ag), nickel (Ni), or the like.

In addition, the external electrodes 31 and 32 are not particularly limited, but may include a conductive metal having 60 weight % or less based on total weight.

The external electrodes 31 and 32 may be formed by applying and firing a conductive paste prepared by adding glass frit to the metal powder.

In general, a thickness of the dielectric layer is reduced in accordance with high capacitance of the multilayered ceramic capacitor.

Here, in the case in which a ceramic green sheet is formed, the internal electrodes are printed thereon and multilayered, and a firing process is performed, since the dielectric layer and the internal electrodes are not evenly attached to each other, the internal electrodes may have a bend in a portion thereof due to surface roughness of the dielectric and the internal electrodes.

A region having a thickness less than those of the other regions may be generated in a single dielectric layer due to the bending of the internal electrodes, and the possibility that dielectric breakdown may be generated in the region of the dielectric layer having the reduced thickness is increased.

In addition, as the dielectric 1 and the internal electrodes 21 and 22 are co-fired, the temperature at which a material configuring the dielectric 1 is sintered is different from the temperature at which a material configuring the internal electrodes 21 and 22 is sintered, such that a difference in a contraction rate between two materials is generated, whereby cracks may be significantly generated in the multilayered ceramic electronic component.

Therefore, in the case in which the internal electrodes 21 and 22 include a single ceramic layer 23 therein to have a structure in which the internal electrodes 21 and 22 are configured of first metal layers 21a and 22a, second metal layers 21b and 22b, and a single ceramic layer 23 between the first and second metal layers 21a and 21b and the first and second metal layers 22a and 22b; even in the case that pores are generated by a difference in a contraction rate between two materials generated due to a difference between the sintering temperatures of two materials caused by co-firing of the dielectric 1 and the internal electrodes 21 and 22, the electrode connectivity and the coverage may be maintained and capacitance may be maintained, whereby a disconnection generated by a difference in contraction and extension rates may be prevented.

The ceramic layer 23 may be formed of barium titanate (BaTiO₃), the same as a material configuring the dielectric 1, such that the disconnection generated by the difference in contraction and extension between the internal electrodes 21 and 22 and the dielectric 1 may be prevented. Therefore, the same material as the dielectric 1 may be used in the internal electrodes 21 and 22.

The ceramic layer 23 may have a thickness corresponding to 10% to 30% of thickness of the internal electrode 21 or 22. Here, in the case in which the thickness of the ceramic layer is 10% or less of the thickness of the internal electrode 21 or 22, it may be insufficient to prevent the disconnection of the internal electrodes 21 and 22, and in the case in which the thickness of the ceramic layer 23 is 30% or more of the thickness of the internal electrode 21 or 22, it may exceed the thickness thereof to prevent the disconnection of the internal electrodes 21 and 22, which is not suitable therefor.

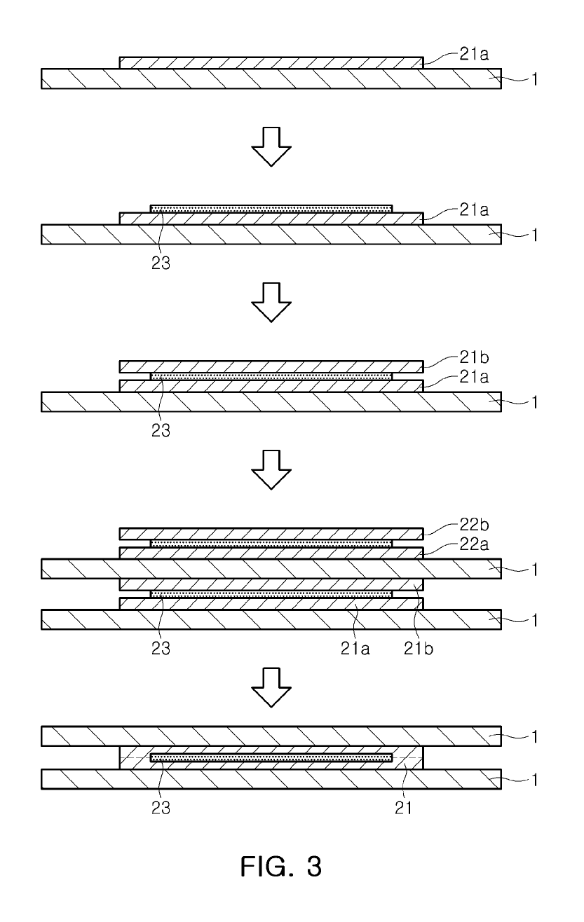

FIG. 3 is a flow chart showing a process of forming the internal electrodes 21 and 22 including the first metal layers 21a and 22a, the second metal layers 21b and 22b, and the ceramic layer 23 between the first and second metal layers 21a and 21b and the first and second metal layers 22qa and 22b.

Referring to FIG. 3, the dielectric sheet is first prepared, and then the first metal layers 21a and 22a are primarily printed thereon. The ceramic layer 23 is printed on the first metal layers 21a and 22a, and the second metal layers 21b and 22b are then printed on the ceramic layer 23 to form the internal electrodes 21 and 22.

The ceramic layer 23 is printed by at least one method selected from a group consisting of a screen printing method, a chemical vapor deposition method, and a physical vapor deposition method.

The screen printing method indicates a process of passing an ink through a screen and transferring a required pattern to an object to be printed. This method has been utilized in various fields such as forming a circuit wiring of a substrate, forming an electrode of a display panel, and forming an electrode of a solar cell.

The CVD and the PVD are general methods of depositing a thin film. A difference between two methods depends on what procedure is performed during deposition of a material on a substrate, changing from a gaseous state to a solid state. In the CVD, a raw material moves by a gas in a thin film deposition process; however, the material is chemically changed on a surface thereof, and in the PVD, the material is physically changed when the material is changed from a gaseous state to a solid state.

By the above-described methods, the dielectric 1 and the internal electrodes 21 and 22 are sequentially multilayered in a plurality of layers, compressed and fired to be formed. Here, as described above, the thickness of the ceramic layer 23 should be 10% to 30% of the thickness of the internal electrode 21 or 22.

In the multilayered ceramic electronic component according to another embodiment of the present invention, descriptions overlapped with the description of the multilayered ceramic electronic component according to one embodiment of the present invention will be omitted.

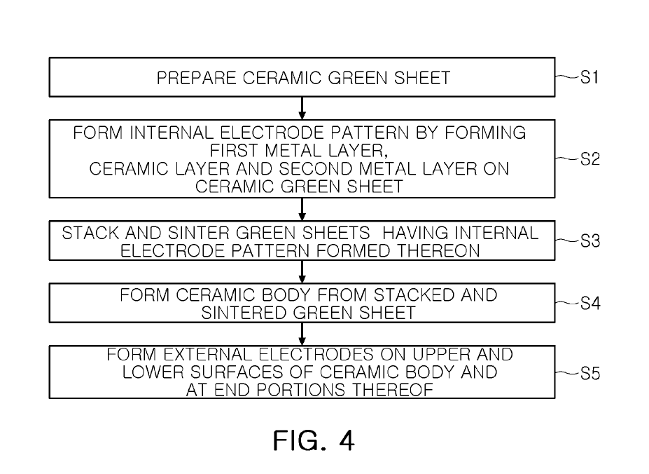

FIG. 4 is a view showing a fabricating process of a multilayered ceramic capacitor according to another embodiment of the present invention.

Referring to FIG. 4, the fabricating method of the multilayered ceramic electronic component may includes: preparing ceramic green sheets including dielectric layers S1; forming an internal electrode pattern on the ceramic green sheet by using a conductive paste for an internal electrode including a conductive metal powder and a ceramic powder S2; multilayering and sintering the green sheets respectively having the internal electrode pattern formed thereon S3 to form a ceramic body including internal electrodes therein, the internal electrodes being disposed so as to face each other S4; and forming external electrodes on upper and lower surfaces of the ceramic body and on end surfaces thereof S5, wherein the forming of the internal electrode pattern S2 is performed by forming a first metal layer on the ceramic green sheet, forming a ceramic layer on the first metal layer, and forming a second metal layer on the ceramic layer.

In the fabricating method of the multilayered ceramic electronic component according to the embodiment of the present invention, a slurry containing a powder such as a barium titanate (BaTiO₃) powder, or the like, may be applied to a carrier film and dried thereon to prepare a plurality of ceramic green sheets, thereby forming the dielectric layer.

The ceramic green sheet may be produced by preparing a slurry obtained by mixing a ceramic powder, a binder, and a solvent, and then forming the slurry as a sheet having a thickness of several μm by using a doctor blade method.

Then, a conductive paste for an internal electrode including a conductive metal powder and a ceramic powder may be prepared. An average size of the conductive metal powder particles may be 0.05 to 0.2 μm.

The conductive metal powder may be at least one of silver (Ag), lead (Pb), platinum (Pt), nickel (Ni), and copper (Cu).

The conductive paste for the internal electrode is applied on the green sheet by a screen printing method to form the internal electrodes 21 and 22. Here, when the internal electrodes 21 and 22 are formed, the first metal layers 21a and 22a may be formed on the ceramic green sheet, the ceramic layer 23 may be formed on the first metal layers 21a and 22a, and the second metal layers 21b and 22b may be formed on the ceramic layer 23.

That is, the internal electrodes 21 and 22 may include two metal layers and a single ceramic layer 23 formed between the two metal layers in the same order as the above-description of FIG. 3.

Then, the green sheets may be multilayered and sintered to form the ceramic body 10 including the internal electrodes 21 and 22 disposed to face each other, having the dielectric layer 1 therebetween.

Next, a compressing process and a cutting process may be performed to form a chip having a 1005 standard size (length×width×thickness is 1.0 mm×0.5 mm×0.5 mm), and the chip may be fired at a temperature of 1050-1200° C. under a reduction atmosphere of 0.1% or less of H₂ to form the ceramic body 10.

The ceramic body may include barium titanate (BaTiO₃).

Then, a conductive paste for an external electrode including a conductive metal may be prepared, and the conductive paste for the external electrode is applied to end surfaces of the ceramic body to form the external electrodes 31 and 32 so as to be respectively electrically connected to the internal electrodes 21 and 22.

The external electrodes 31 and 32 may be prepared by dipping both end portions of the ceramic body 10 in the conductive paste for the external electrodes, but are not limited thereto, and thus, may be fabricated by various methods.

Parts which are the same as the characteristics of the multilayered ceramic electronic components according to the afore-mentioned embodiment of the present invention will be omitted.

As set forth above, according to embodiments of the present invention, the disconnection generated by a difference in contraction and extension rates due to a difference in the sintering temperature between the internal electrodes and the dielectric may be prevented and the electrode connectivity and the coverage may be maintained, whereby the high capacitance multilayered ceramic electronic component having excellent reliability may be implemented.

While the present invention has been shown and described in connection with the embodiments, it will be apparent to those skilled in the art that modifications and variations can be made without departing from the spirit and scope of the invention as defined by the appended claims.

What is claimed is:

1. A multilayered ceramic electronic component comprising:
a ceramic body including dielectric layers;
internal electrodes disposed to face each other, having the dielectric layer therebetween; and
external electrodes formed on an outer side of the ceramic body and respectively electrically connected to the internal electrodes,
the internal electrodes including a single ceramic layer therein.

2. The multilayered ceramic electronic component of claim 1, wherein the internal electrodes include two metal layers and a single ceramic layer formed between the two metal layers.

3. The multilayered ceramic electronic component of claim 1, wherein the two metal layers include nickel (Ni).

4. The multilayered ceramic electronic component of claim 1, wherein the ceramic layer has a thickness corresponding to 10% to 30% of a thickness of the internal electrode.

5. The multilayered ceramic electronic component of claim 1, wherein the ceramic layer includes barium titanate (BaTiO₃).

6. The multilayered ceramic electronic component of claim 1, wherein the number of multilayered dielectric layers is 100 to 1000.

7. A fabricating method of a multilayered ceramic electronic component, the fabricating method comprising:
preparing ceramic green sheets including dielectric layers;
forming an internal electrode pattern on the ceramic green sheet by using a conductive paste for an internal electrode including a conductive metal powder and a ceramic powder;
multilayering and sintering the green sheets respectively having the internal electrode pattern formed thereon to form a ceramic body including internal electrodes therein, the internal electrodes being disposed to face each other; and
forming external electrodes on upper and lower surfaces of the ceramic body and at end surfaces thereof,
the forming of the internal electrode pattern being performed by forming a first metal layer on the ceramic green sheet, forming a ceramic layer on the first metal layer, and forming a second metal layer on the ceramic layer.

8. The fabricating method of claim 7, wherein the internal electrodes include two metal layers and a single ceramic layer formed between the two metal layers.

9. The fabricating method of claim 7, wherein the conductive metal powder is at least one of silver (Ag), lead (Pb), platinum (Pt), nickel (Ni), and copper (Cu).

10. The fabricating method of claim 7, wherein the ceramic layer has a thickness corresponding to 10% to 30% of a thickness of the internal electrode.

11. The fabricating method of claim 7, wherein the ceramic layer is printed by at least one method selected from a group consisting of a screen printing method, a chemical vapor deposition (CVD) method, and a physical vapor deposition (PVD) method.

12. The fabricating method of claim 7, wherein the ceramic layer includes barium titanate (BaTiO₃).

13. The fabricating method of claim 7, wherein the number of multilayered dielectric layers is 100 to 1000.
